(19) United States
(12) Patent Application Publication
(10) Pub. No.: US 2007/0101714 A1
(43) Pub. Date: May 10, 2007

(54) Exhaust gas turbocharger for an internal combustion engine and method of operating an exhaust gas turbocharger

(76) Inventors: Markus Duesmann, Northamptonshire (GB); Matthias Gregor, Stuttgart (DE); Jens Meintschel, Esslingen (DE); Thomas Stolk, Kirchheim (DE); Alexander von Gaisberg-Helfenberg, Beilstein (DE)

Correspondence Address: KLAUS J. BACH, 4407 TWIN OAKS DRIVE, MURRYSVILLE, PA, 15668, US

(21) Appl. No.: 11/607,823

(22) Filed: Dec. 2, 2006

Related U.S. Application Data
(63) Continuation-in-part of application No. PCT/EP05/03097, filed on Mar. 23, 2005.

(30) Foreign Application Priority Data
Jun. 2, 2004 (DE) 10 2004 026 796.0

(51) Int. Cl. F02B 33/44

(52) U.S. Cl. 60/598; 60/605.1

(57) ABSTRACT

In an exhaust gas turbocharger for an internal combustion engine comprising a compressor and a turbine interconnected by a shaft in a rotationally fixed manner, and an electric machine which can be connected to the exhaust gas turbocharger via a clutch, the exhaust gas turbocharger can be driven at least temporarily by a disk-shaped flywheel rotatably supported on the shaft and being operable selectively by the turbine and by an electro-dynamic structure for improving the response behavior of the exhaust gas turbocharger.

This is a Continuation-In-Part Application of pending international patent application PCT/EP2005/003097 filed Mar. 23, 2005, and claiming the priority of German patent application 10 2004 026 796.0 filed Jun. 2, 2004.

### BACKGROUND OF THE INVENTION

The invention relates to an exhaust gas turbocharger for an internal combustion engine and a method for operating an exhaust gas turbocharger including a turbine and a compressor with a common shaft and an electric machine connected thereto via a disengageable clutch.

Exhaust gas turbochargers are used both in spark-ignition and auto-ignition internal combustion engines to increase the cylinder charge. Increasing the cylinder charge both increases the engine power and also increases the combustion air ratio, and thus reduces the formation of soot in the lower and intermediate load and rotational speed ranges of auto-ignition internal combustion engines. It can also result in a reduction of nitrogen oxide emissions, depending on the combustion temperature.

Exhaust gas turbochargers generally comprise two turbo-machines which are coupled by means of a shaft, a turbine, to which the expanding exhaust gas mass flow of the internal combustion engine is applied and a compressor which is driven by the turbine via the shaft and compresses intake air. Since turbo-machines have an operating behavior different from internal combustion engines, exhaust gas turbochargers and/or their peripherals have to be designed in such a way that sufficient air is made available by the exhaust gas turbocharger both in the low and in the upper load and rotational speed ranges in order to achieve the desired operating behavior of the internal combustion engine.

When there is a sudden increase in the load and/or rotational speed of the internal combustion engine, the exhaust gas turbocharger reacts in a delayed manner because of its mass inertia. This delayed response behavior is known as “turbo lag” and is distinguished by the fact that the exhaust gas turbocharger of the internal combustion engine supplies momentarily an amount of air which is insufficient for the corresponding engine operating point. In the non-steady state operating mode of the internal combustion engine the poor response behavior causes both insufficient acceleration and high fuel consumption, which could be reduced by eliminating the poor response behavior.

If the exhaust gas turbocharger is configured for the rated power point of the internal combustion engine, it is generally too large for rapid response in the lower and intermediate load and rotational speed ranges and, because of its mass inertia, provides results in an unsatisfactory operating behavior of the internal combustion engine in terms of engine torque, agility and consumption. There are different approaches for improving the response behavior of the exhaust gas turbocharger in the aforesaid range.

One of the approaches in this regasd is to couple the exhaust gas turbocharger to an electric machine. The electric machine is rigidly connected to the exhaust gas turbocharger and accelerates it when necessary. The necessary power levels are approximately 1-2 kW for a four cylinder engine, for example. With such a high power consumption, current motor vehicle onboard power systems are at their power limit. A large part of the energy is required to accelerate the electric machine itself. The electric machine's rotor which is connected to the exhaust gas turbocharger substantially reduces the dynamics of the exhaust gas turbocharger in the unsupported operating range owing to the mass inertia of its rotor.

JP 57 059025 A discloses an exhaust gas turbocharger comprising a compressor and a turbine, the compressor being connected to the turbine via a shaft in a rotationally fixed manner. The exhaust gas turbocharger includes an electric machine which can be connected to the exhaust gas turbocharger via a clutch, the exhaust gas turbocharger being able to be driven at least temporarily by a disk-shaped flywheel, said disk-shaped flywheel being able to be connected to the exhaust gas turbocharger via the clutch. The disk-shaped flywheel is connected to the exhaust gas turbocharger by dry friction.

EP 0 420 666 B1 discloses a method for an exhaust gas turbocharger comprising a compressor and a turbine and also comprising a shaft which connects the compressor and the turbine to one another in a rotationally fixed manner. An electric machine can be connected to the exhaust gas turbocharger via a clutch. At a rotational speed n_{ATL} of the exhaust gas turbocharger which is higher than a rated rotational speed nₖₒₙₜₛ of the flywheel, the electric machine for driving the flywheel is not active but rather absorbs excess energy which is present at the exhaust gas turbocharger in the mode of operation of the electric machine as a generator, and feeds the excess energy, for example, into a motor vehicle onboard power system, the drive of the flywheel being maintained by means of the exhaust gas turbocharger.

Furthermore, EP 0 345 991 B1 discloses an exhaust gas turbocharger for an internal combustion engine. The exhaust gas turbocharger has an exhaust gas turbine and a compressor. The turbine and the compressor are connected to one another via a shaft in a rotationally fixed manner. An electric machine can be connected to the exhaust gas turbocharger via a clutch. Furthermore, the exhaust gas turbocharger includes an electric machine which can be connected to the turbocharger via a clutch.

The exhaust gas turbocharger includes a generator which can be operated by the internal combustion engine via a clutch located between the generator and the internal combustion engine. The electric energy produced in the process is supplied to the rotating electric machine which then operates as an electric motor and drives the exhaust gas turbocharger. When the exhaust gas turbocharger is driven which results in an increase of the rotational speed of the exhaust gas turbocharger, the compressor is operated in a characteristic diagram range in which it supplies the internal combustion engine with quantities of air adapted to the engine operating points. In this process, the generator is connected to the crankshaft of the internal combustion engine via a clutch so that an increased torque occurs at the crankshaft of the internal combustion engine. As a result, the fuel consumption is increased while the effective average pressure of the internal combustion engine remains the same.

It is the object of the present invention to connect an electric machine to an exhaust gas turbocharger in such a way that the response time of the exhaust gas turbocharger is reduced. Also, little installation space should be required and energy requirements should low. Furthermore the transient response behavior of the exhaust gas turbocharger is to be improved and excess energy of the exhaust gas turbocharger should be utilized.

### SUMMARY OF THE INVENTION

In an exhaust gas turbocharger for an internal combustion engine comprising a compressor and a turbine interconnected by a shaft in a rotationally fixed manner, and an electric machine which can be connected to the exhaust gas turbocharger via a clutch, the exhaust gas turbocharger can be driven at least temporarily by a disk-shaped flywheel rotatably supported on the shaft and being operable selectively by the turbine and by an electro-dynamic structure for improving the response behavior of the exhaust gas turbocharger.

In this way, the power requirement for accelerating the exhaust gas turbocharger does not have to be met by an electric machine since the energy necessary to accelerate the exhaust gas turbocharger is transmitted to the exhaust gas turbocharger with a high power density by the rotational energy of the flywheel. Where necessary, the connection between the flywheel and the exhaust gas turbocharger is established or eliminated by means of the clutch. Furthermore, the flywheel can be driven by an electric machine. The electric machine compensates for the frictional losses occurring at the flywheel. Where necessary, it can accelerate the flywheel or generate energy. The power demand which is incurred for compensating the frictional losses or for accelerating the flywheel is low so that the load on the onboard power system is negligible. The clutch is composed of a disk which is connected in a rotationally fixed manner to a shaft of the exhaust gas turbocharger, a pole structure, a yoke and a coil, an air gap preventing friction between the disk connected to the exhaust gas turbocharger and the pole structure.

In a particular embodiment, the flywheel comprises the pole structure for increasing the effective flywheel. In addition, the pole structure is part of the clutch via which the exhaust gas turbocharger can be coupled to the flywheel or the electric machine.

In a further embodiment, the pole structure has at least two disks for a functionally reliable clutch.

In a further embodiment, the disks of the pole structure are constructed in an annular shape for reasons of weight. If the exhaust gas turbocharger is accelerated by the flywheel a large flywheel is desired. However, the flywheel has to be accelerated itself before it can accelerate the exhaust gas turbocharger. In contrast, in that process, a small mass is desired. For this reason, an annular shape like that of the pole structure, is the shape which is most advantageous in terms of weight.

In a further embodiment, a disk which is connected to the shaft of the exhaust gas turbocharger in a rotationally fixed manner as a component of the clutch is arranged between the disks of the pole structure.

In a further embodiment, the disks of the pole structure include a toothed structure with teeth and tooth gaps, the teeth of one disk lying opposite the tooth gaps of the other disk. The toothed structure and in particular the positioning of the teeth and of the tooth gaps opposite one another, are necessary to the design of a functionally reliable clutch, since by virtue of this design an induced magnetic flux can be divided in the disk which is positioned between the two disks of the pole structure, and is deflected and exerts a torque on the disk by virtue of the deflection.

In a further embodiment, the two disks of the pole structure are held together by means of a non-magnetic strap. Owing to the centrifugal forces occurring during a rotational movement, the two disks can be deformed. A functionally reliable clutch could not be ensured without a strap. The non-magnetic strap holds the two disks together even at high rotational speeds in such a way that the two disks are spaced apart from one another in parallel. This ensures a functionally reliable clutch.

In a further embodiment, for reasons of weight and installation space the flywheel is composed of a rotor of the electric machine, a disk, a tubular element and the pole structure.

In a further embodiment, the pole structure is connected in a rotationally fixed manner to the rotor of the electric machine via the disk and the tubular element, both to increase the effective flywheel and to increase the rotational speed of the flywheel.

In a further embodiment, the clutch is arranged between the compressor and the turbine of the exhaust gas turbocharger in order to protect the electric machine against high temperatures and the compressor against the ingress of oil.

In a further embodiment, the clutch is an eddy current clutch or a hysteresis clutch. This provides for wear-free operation and good electrical actuation properties.

In still another embodiment, the flywheel is held as far as possible at a minimum rotational speed which corresponds to a rated rotational speed, by means of the electric machine or by means of the exhaust gas turbocharger, in order to ensure sufficient rotational energy of the flywheel for the acceleration of the exhaust gas turbocharger.

In the method according to the invention for operating the exhaust gas turbocharger, when a rotational speed of the exhaust gas turbocharger is higher than a rated rotational speed of the flywheel, the electric machine is not active in order to drive the flywheel but rather said electric machine absorbs the excess energy of the exhaust gas turbocharger in its operating mode as a generator and feeds the acquired energy, for example, into a motor vehicle onboard power system, while the flywheel is driven by the exhaust gas turbocharger. In order to accelerate the exhaust gas turbocharger in the operating ranges in which the rotational speed of the exhaust gas turbocharger is lower than the rated rotational speed of the flywheel, the electric machine is used to accelerate the flywheel only if the rotational speed of the flywheel drops below its rated rotational speed, in order to ensure sufficient rotational energy of the flywheel at a later time.

In one development of the method according to the invention, in operating ranges in which the rotational speed of the exhaust gas turbocharger corresponds at least to the rated rotational speed of the flywheel, the flywheel is accelerated by the exhaust gas turbocharger with the clutch closed so that the electric machine can be switched off as an energy saving measure.

In a further embodiment of the method according to the invention, the exhaust gas turbocharger is driven by the flywheel in operating ranges in which the rotational speeds of the exhaust gas turbocharger are lower than the rotational speed of the flywheel.

The invention will become more readily apparent from the following description of particular embodiments thereof on the basis of the accompanying:

### BRIEF DESCRIPTION OF THE DRAWINGS

FIG. 1 is a schematically simplified sectional illustration of an exhaust gas turbocharger according to the invention,

FIG. 2 is an exploded illustration of the exhaust gas turbocharger according to the invention,

FIG. 3 is a perspective detail view of a pole structure of the exhaust gas turbocharger, and

FIG. 4 is a developed view of the pole structure showing magnetic flux lines occurring during operation when the coil is energized.

### DESCRIPTION OF A PARTICULAR EMBODIMENT

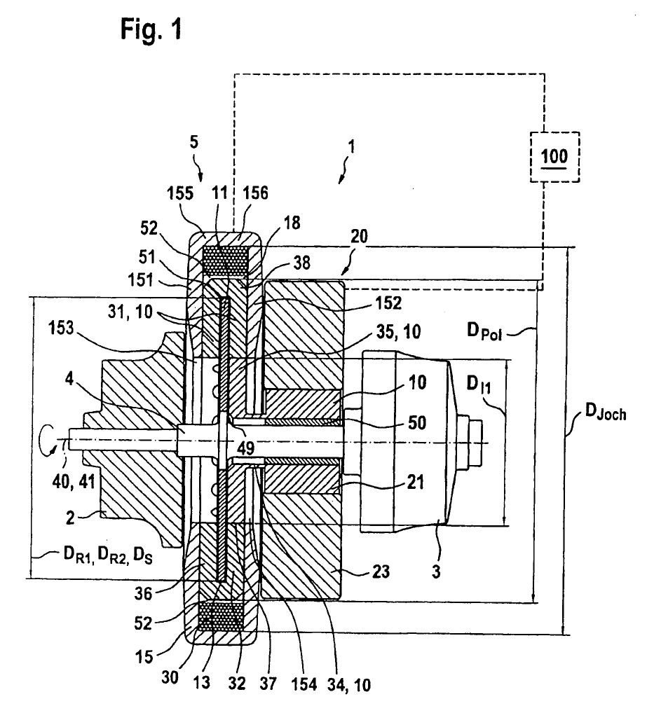

FIG. 1 illustrates an exhaust gas turbocharger 1 of an internal combustion engine, for example a spark ignition engine or a diesel engine. The internal combustion engine, which is preferably used in motor vehicles, has an intake section with, for example, inlet valves via which air is fed to a combustion chamber of the internal combustion engine. The air is used to burn fuel which is either added to the air outside the combustion chamber or inside the combustion chamber. The fuel/air mixture in the combustion chamber is subsequently burnt. The burning of the fuel/air mixture produces exhaust gas which passes from the combustion chamber into an exhaust section via, for example, outlet valves. Some of the exhaust gas energy can then be used to increase the air supply to the combustion chamber by means of the exhaust gas turbocharger 1 arranged in the air or gas flow circuit of the internal combustion engine.

The exhaust gas turbocharger 1 includes a turbine 3 which is provided downstream of the outlet valves in the exhaust section of the internal combustion engine and a compressor 2 which is disposed upstream of the inlet valves in the intake section of the internal combustion engine. The turbine 3 is driven by the exhaust gas of the internal combustion engine and drives the compressor 2 via a shaft 4, so that air can be sucked in, and compressed by, the compressor 2. The shaft 4 has a rotational axis 40. The rotating components of the exhaust gas turbocharger 1, such as the compressor 2, turbine 3 and shaft 4, are supported in a housing of the exhaust gas turbocharger 1 by means of bearings (not illustrated).

An electric machine 20, a clutch 5, which connects the electric machine 20 to the shaft 4 of the exhaust gas turbocharger 1, and a flywheel 10, which drives the exhaust gas turbocharger 1, are arranged on the shaft 4 between the compressor 2 and the turbine 3. The electric machine 20 is connected fixed in terms of rotation to the clutch 5.

The electric machine 20 is composed of a cylindrical rotor 21 and stator 23 which surrounds the rotor 21. The rotational axis 40 of the shaft 4 corresponds to a rotational axis 41 of the rotor 21. A bearing 50, for example a sliding bearing, is provided between the rotor 21 and the shaft 4 and permits the rotor 21 to rotate independently of the shaft 4, at a rotational speed which differs from the rotational speed of the shaft 4. The electric machine 20 is connected to a motor vehicle onboard power system 100 of the internal combustion engine.

The clutch 5 which is arranged at the compressor end comprises a first disk 11 which is connected fixed in terms of rotation to the shaft 4 of the exhaust gas turbocharger 1, a pole structure 31 which bounds the first disk 11 peripherally in a prong-shaped form, a yoke 15 which surrounds the pole structure 31 and a coil 30 which is accommodated in the yoke 15. The pole structure 31 can also be referred to as an element of the clutch 5 which rotates with it. Rotating parts of the clutch 5 are of disk-shaped design so that exclusively tensile stresses in the material can arise due to the centrifugal force. The shaft 4, the clutch 5 and the rotor 21 have the same rotational axis 40.

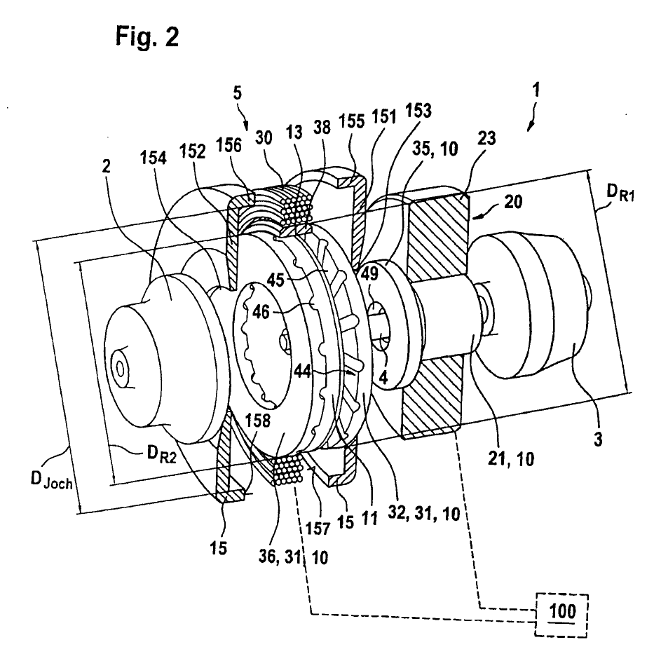

FIG. 2 shows an exploded illustration of the exhaust gas turbocharger 1 for the sake of further clarity. The yoke 15 which surrounds the pole structure 31 comprises two round, disk-shaped covers, a first cover 151 and a second cover 152, the covers 151, 152 having a first collar 155, and respectively a second collar 156, which are arranged perpendicularly to a cover plane. A first round opening 153 and a second round opening 154 for accommodating the shaft 4 are formed in the center of the covers 151, 152. The covers 151, 152 are in mirror-inverted positions with respect to one another so that a first end face 157 of the first collar 155 adjoins a second end face 158 of the second collar 156. The end faces 157, 158 which point towards one another are permanently connected to one another after mounting, for example by welding or soldering.

The yoke 15 is embodied in two parts for reasons of mounting. It could also be embodied in such a way that the two openings 153 and 154 of the covers 151, 152 have a diameter in the order of magnitude of the diameter of the shaft 4 in order to accommodate the shaft 4 without friction. Likewise, bearings of the shaft 4 could also be integrated into the openings 153, 154 of the yoke 15.

The yoke 15 accommodates the pole structure 31. The pole structure 31 is of three-part design. A first part of the pole structure 31 forms a first annular disk 32 which has a toothed structure 44 and an external diameter D_{R1} and a cavity 37 (illustrated in more detail in FIG. 1) with a diameter D_{I1}. A second part of the pole structure 31 (illustrated in FIG. 2) forms a second annular disk 36 with an external diameter D_{R2} which also has the toothed structure 44. The first disk 11 which is connected in a rotationally fixed manner to the shaft 4 is arranged between the first annular disk 32 and the second annular disk 36.

The first annular disk 32 and the second annular disk 36 are held together at their circumference by a third part of the pole structure 31, a non-magnetizable strap 38 in such a way that their disk faces are arranged parallel to one another. If the strap 38 were not present, centrifugal forces occurring during the operation of the clutch 5 would deform the two annular disks 32, 36 with the result that the coupling function of the clutch 5 could no longer be ensured. In order to prevent friction between the first disk 11 and the strap 38, a radial depression 13 is provided in the strap 38 opposite the first disk 11.

The external diameter D_{R1} of the first annular disk 32 and the external diameter D_{R2} of the second annular disk 36 correspond to the external diameter D_{S} of the first disk 11. An internal diameter D_{Joch} of the yoke 15 is larger than an external diameter D_{Pol} of the pole structure 31 so that an annular space 18 remains in the yoke 15. This annular space 18 which is present is provided to accommodate the coil 30. The coil 30 which is accommodated in the yoke 15 serves to generate a magnetic field. For this purpose, the coil 30 is supplied with current by the motor vehicle onboard power system 100.

Between the rotatable pole structure 31 and the yoke 15 as well as between the strap 38 which rotates with the pole structure 31 and the coil 30 there is an air gap 52 (illustrated in more detail in FIG. 1). The air gap 52 prevents friction between the pole structure 31 and the yoke 15 or between the strap 38 and the coil 30.

A connection of the electric machine 20 to the clutch 5 is realized by a second disk 35 which accommodates the shaft 4, and a tubular element 34 which accommodates the shaft 4 and is connected in a rotationally fixed manner to the second disk 35. One end of the tubular element 34 which faces the electric machine 20 is connected in a rotationally fixed manner to the rotor 21. One end of the tubular element 34 which faces the clutch 5 is connected in a rotationally fixed manner to the second disk 35. The second disk 35 is connected in a rotationally fixed manner to the first annular disk 32 in such a way that the first annular disk 32 accommodates the second disk 35 in its cavity 37. The second disk 35 has an opening 49 for accommodating the shaft 4.

The rotationally fixed accommodation of the second disk 35 in the cavity 37 of the first annular disk 32 can, for example, be effected by positive engagement. Likewise, the first annular disk 32 and the second disk 35 can also be embodied in one piece and the second disk 35 could then also have the toothed structure 44 corresponding to the first annular disk 32. Although the toothed structure 44 on the second disk 35 would not have a function since there would be no toothed structure 44 on the second annular disk 36 lying opposite to it, this would be easier to manufacture in terms of fabrication technology than a disk with a crown gear which has the toothed structure 44, and a face which is surrounded by the crown gear and does not have a toothed structure 44.

An air gap 51 is formed between the first disk 11 and the pole structure 31. The air gap 51 in the first instance prevents friction between the annular disks 32, 36 and the first disk 11 or between the strap 38 and the first disk 11, and in the second instance serves as a carrier for magnetic flux 54 which is induced by the coil 30. The pole structure 31 could also be of single part or two part design. In this context, the mounting possibilities of the first disk 11 which is arranged between the annular disks 32, 36 are to be noted.

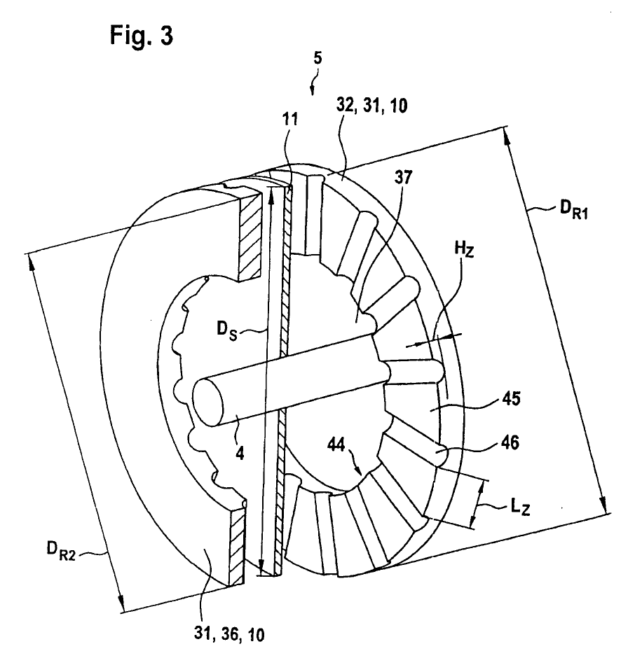

FIG. 3 illustrates a detail of the pole structure 31 of the exhaust gas turbocharger 1. The first and second annular disks 32, 36 have a toothed structure 44 with teeth 45 and tooth gaps 46 which are adjacent to the teeth 45 on their surfaces which respectively face the first disk 11. The teeth 45 have a tooth height H_{Z} in the axial direction and a tooth length L_{Z} in the circumferential direction. The toothed structure 44 of the first and second annular disks 32, 36 is embodied in such a way that the teeth 45 of the first annular disk 32 lie opposite the tooth gaps 46 in the second annular disk 36.

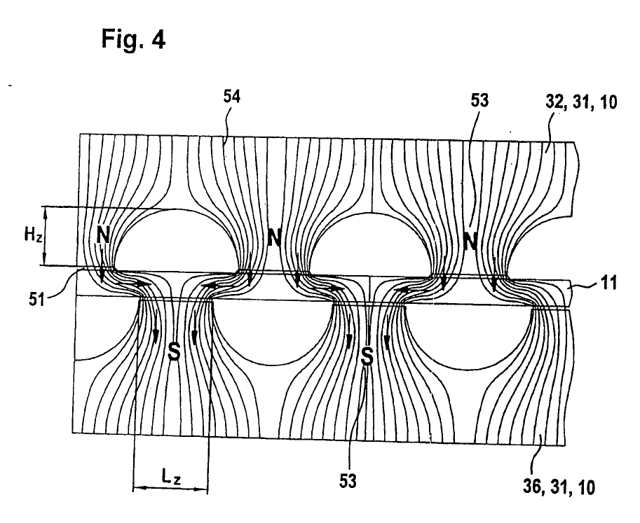

FIG. 4 shows a developed view of the pole structure 31 showing magnetic flux 54 occurring during operation when current is flowing through the coil 30 and magnetic poles 53. The magnetic flux 54 is induced by the coil 30 (not illustrated in FIG. 3) through which current flows. The magnetic poles 53 are formed in the teeth 45 of the first annular disk 32 and of the second annular disk 36. Owing to the direction of flow of the magnetic flux 54, the poles 53 can be divided into north poles and south poles, marked N and S, respectively, in FIG. 4. If the coil 30 does not have current flowing through it, no magnetic flux 54 is induced.

In FIG. 4, the north pole is formed in the first annular disk 32, and the south pole in the second annular disk 36. The first disk 11 which is positioned between the two annular disks 32, 36 is penetrated by the magnetic flux 54. Owing to this penetration and the teeth which are located offset with respect to one another in the annular disks 32, 36, a change occurs in the magnetization (remagnetization) of the first disk 11 when there is a rotational movement of the first disk 11 at a rotational speed which is different from a rotational speed of the annular disks 32, 36 of the pole structure 31.

It is possible to realize a functional principle of hysteresis or of an eddy current in the clutch 5. Whether the rotational movement or the rotational speed of the pole structure 31 corresponds or not is dependent on the functional principle used for the clutch 5.

If the principle of hysteresis is used, the first disk 11 is composed of semihard material which has a pronounced hysteresis loop in the flux density B—field strength H—diagram, referred to for short as B-H diagram. The pole structure 31 is made of soft magnetic material, for example, iron. The teeth 45 of the pole structure 31 which are offset with respect to one another cause the magnetic flux 54 which penetrates each pole 53 to be divided into two parts and to pass through the first disk 11 partially in the tangential direction. In this context, the first disk 11 which is composed of the magnetically semihard material is magnetized. In an ideal case, the directions of the two partial fluxes emanating from a pole 53 will be offset by 180 degrees with respect to one another.

If the pole structure 31 rotates through, for example, one tooth length L_{Z}, the location in the first disk 11 which has just been magnetized is penetrated in the other direction by the magnetic flux 54. The first disk 11 is magnetized in the opposite direction. The work which is performed owing to the remagnetization corresponds to the area of a hysteresis loop and is referred to as remagnetization work.

The re-magnetization work generates a torque in the first disk 11 and an electromagnetic connection is produced between the pole structure 31 and the first disk 11, as a result of which the connection of the exhaust gas turbocharger 1 is ultimately formed to the electric machine 20 via the clutch 5 and the first disk 11 with its rotationally fixed connection to the shaft 4. The clutch 5 is then closed. In the case of the clutch 5 according to the principle of hysteresis, the first disk 11 and the pole structure 31 assume the same rotational speed.

If the eddy current principle is used, an electrically conductive material, for example iron, copper or aluminum, is to be used for the first disk 11. When the first disk 11 is rotated, a locally induced magnetic field of the magnetic flux 54 is changed in terms of its strength and its direction. Due to the eddy currents which are locally induced due to changes in the magnetic field and are perpendicular to the magnetic field, magnetic fields are in turn generated which are directed in the opposite direction to the applied magnetic field. This produces a torque which gives rise to an electromagnetic connection between the pole structure 31 and the first disk 11, as a result of which ultimately the connection of the exhaust gas turbocharger 1 to the electric machine 20 is formed via the clutch 5 and the first disk 11 with its rotationally fixed connection to the shaft. The clutch 5 is thus closed.

With an eddy current clutch, the torque which occurs is dependent on the relative rotational speed of the first disk 11 and of the pole structure 31, that is to say an approximation of the rotational speed of the first disk 11 and of the pole structure 31 is not possible. The material used in eddy current clutches is advantageously more resistant to bursting than the material of hysteresis clutches.

According to both functional principles no magnetic flux 54 is produced in the pole structure 31 and no connection is formed between the electric machine 20 and the exhaust gas turbocharger 1 if current does not flow through the coil 30. The clutch 5 is then opened.

For both types of clutch, the coil 30 and the stator 23 are arranged in a stationary fashion and the magnetic flux 54 is transmitted into the pole structure 31 via the air gap 52. The first annular disk 32 which is connected to the rotor 21 via the tubular element 34 and the second disk 35 is held together with the second annular disk 36 by means of the strap 38 and said annular disks 32, 36 are subjected to pure tensile stress owing to the centrifugal force acting as a result of the rotation.

The rotatable rotor 21 which is excited to permanent rotational movement by the electric machine 20 as required, the rotatable pole structure 31 and the parts which constitute the rotationally fixed connection between the rotor 21 and the pole structure 31, these being the tubular element 34 and the second disk 35 which is connected in a rotationally fixed manner to the tubular element 34, constitute the flywheel 10. In order to increase the rotational speed of the exhaust gas turbocharger 1, the flywheel 10 is connected to the exhaust gas turbocharger 1 via the clutch 5 when necessary.

In order to produce the rotational movement of the flywheel 10 with a rotational speed n_{kontS} of, for example, 100 000 l/min, a power of approximately 100 W has to be applied by the electric machine 20, as a result of which, in contrast to the prior art, a significant reduction in the electric power demand to accelerate the exhaust gas turbocharger 1 is achieved. A further reduction in the power demand can be achieved by reducing, for example, the frictional losses in the bearings (not illustrated in more detail) and/or reducing the air resistance of the flywheel 10. The reduction in the air resistance of the flywheel 10 can be achieved, for example by filling the toothed gaps 46 of the pole structure 31 with non-magnetizable material. The noise emissions can be kept low by filling the toothed gaps 46 with non-magnetizable material.

The inventive use of the rotor 21 and of the disk-shaped pole structure 31 as a flywheel 10 requires less drive power of the electric machine 20, as a result of which the installation space required for the exhaust gas turbocharger 1 according to the invention is significantly reduced compared to previous designs.

While the internal combustion engine is operating in the idling range Lₗₑₑᵣ or a low partial load range L_{Teiln} or in the overrun conditions L_{Schub} at low rotational speeds nₖₗₑᵢₙ the clutch 5 is opened and the exhaust gas turbocharger 1 is not coupled to the electric machine 20. Owing to the low frictional losses and the large amount of rotational energy stored in the flywheel 10, the flywheel 10 rotates at rotational speeds which are higher than a rated rotational speed n_{KontS} of the flywheel 10. The flywheel 10 is not coupled to the electric machine 20 here, that is to say it rotates without energy being supplied by the electric machine 20.

As soon as the speed of the flywheel 10 drops below its rated rotational speed n_{KontS}, the electric machine 20 drives the flywheel 10. The power to be applied by the electric machine 20 must just be sufficient to overcome bearing friction losses and air resistance.

While the internal combustion engine is operating with a high partial load L_{Teilh} and a low rotational speed nₖₗₑᵢₙ, the flywheel 10 is connected to the exhaust gas turbocharger 1 via the then closed clutch 5 and is driven at the corresponding rotational speed of the exhaust gas turbocharger 1 n_{ATL}. The electric machine 20 is switched off in this case.

If the internal combustion engine is operating at a high partial load L_{Teilh} at high rotational speeds n_{gross} or at full load L_{Voll}, the flywheel 10 is connected to the exhaust gas turbocharger 1 and is operated at the corresponding rotational speed n_{ATL} of the exhaust gas turbocharger 1. The rotational speed n_{ATL} of the exhaust gas turbocharger 1 is higher than the continuous rated rotational speed n_{KontS} of the flywheel 10 to such an extent that energy is generated via the electric machine 20 and is fed, for example, into the motor vehicle onboard power system 100.

If the internal combustion engine is in a power demand state, the clutch 5 is closed and the flywheel 10 accelerates the exhaust gas turbocharger 1. In this context, the rated rotational speed n_{KontS} of the flywheel 10 can be reduced during the acceleration process until the electric machine 20 drives the flywheel 10 again so that the rated rotational speed n_{KontS} of the flywheel 10 is reached again. When the required exhaust gas turbocharger rotational speed n_{ATL} is reached, the flywheel 10 is decoupled from the exhaust gas turbocharger 1.

Under motor-braking conditions of the internal combustion engine at high rotational engine speeds, the flywheel 10 which rotates freely is driven by the electric machine 20 as soon as its rotational speed n_{S} is below the rated rotational speed n_{KontS}, so that the flywheel 10 remains at the rated rotational speed n_{KontS}.

What is claimed is:

1. An exhaust gas turbocharger for an internal combustion engine including a compressor (2) and a turbine (3), a shaft (4) interconnecting the compressor (2) and the turbine (3) in a rotationally fixed manner, and an electric machine (20) with a clutch (5) for connection of the electric machine (20) to the exhaust gas turbocharger, a disk-shaped flywheel (10) rotatably supported on the shaft (4) and being connectable to the exhaust gas turbocharger via the clutch (5) for driving the exhaust gas turbocharger at least temporarily, the disk-shaped flywheel (10) being drivable by the electric machine (20) for maintaining a certain minimum speed of the flywheel (10), said clutch (5) comprising a first disk (11), which is connected in a rotationally fixed manner to the shaft (4) of the exhaust gas turbocharger (1), a pole structure (31) disposed adjacent the first disk (11) and extending around the flywheel (10) and a yoke (15) including a coil (30), with an air gap (51) preventing friction between the first disk (11) and the pole structure (31).

2. The exhaust gas turbocharger as claimed in claim 1, wherein the disk-shaped flywheel (10) is provided with the pole structure (31).

3. The exhaust gas turbocharger as claimed in claim 1, wherein the pole structure (31) comprises at least two spaced disks (32, 36).

4. The exhaust gas turbocharger as claimed in claim 3, wherein the spaced disks (32, 36) are annular disks.

5. The exhaust gas turbocharger as claimed in claim 3 wherein the first disk (11) is arranged between the spaced disks (32, 36) of the pole structure (31).

6. The exhaust gas turbocharger as claimed in claim 3, wherein the spaced disks (32, 36) of the pole structure (31) have a toothed structure (44) with teeth (45) and tooth gaps (46), the teeth (45) on one of the spaced disks (32; 36) being arranged opposite the tooth gaps (46) on the other of the spaced disks (36; 32).

7. The exhaust gas turbocharger as claimed in claim 3, wherein the spaced disks (32, 36) of the pole structure (31) are held together by means of a strap (38) of a non-magnetic material.

8. The exhaust gas turbocharger as claimed in claim 1, wherein the flywheel (10) comprises a rotor (21) of the electric machine (20), a disk (35) which is held in the pole structure (31), a tubular element (34) and the pole structure (31).

9. The exhaust gas turbocharger as claimed in claim 1, wherein the pole structure (31) is connected in a rotationally fixed manner to a rotor (21) of the electric machine (20) via a support disk (35) and a tubular element (34).

10. The exhaust gas turbocharger as claimed in claim 1, wherein the clutch (5) is arranged between the compressor (2) and turbine (3) of the exhaust gas turbocharger (1).

11. The exhaust gas turbocharger as claimed in claim 1, wherein the clutch (5) is one of an eddy current clutch and a hysteresis clutch.

12. The exhaust gas turbocharger as claimed in claim 1, wherein the flywheel (10) is maintained at a minimum rotational speed, corresponding to a rated rotational speed (n_{kontS}) selectively by means of the exhaust gas turbocharger (1) or by means of the electric machine (20).

13. A method for operating an exhaust gas turbocharger for an internal combustion engine, including An exhaust gas turbocharger for an internal combustion engine including a compressor (2) and a turbine (3), a shaft (4) interconnecting the compressor (2) and the turbine (3) in a rotationally fixed manner, and an electric machine (20) with a clutch (5) for connection of the electric machine (20) to the exhaust gas turbocharger, a disk-shaped flywheel (10) rotatably supported on the shaft (4) and being connectable to the exhaust gas turbocharger via the clutch (5) for driving the exhaust gas turbocharger at least temporarily, the disk-shaped flywheel (10) being drivable by the electric machine (20) for maintaining a certain minimum speed of the flywheel (10), said clutch (5) comprising a first disk (11), which is connected in a rotationally fixed manner to the shaft (4) of the exhaust gas turbocharger (1), a pole structure (31) disposed adjacent the first disk (11) disposed around the flywheel (10) and a yoke (15) including a coil (30), with an air gap (51) preventing friction between the first disk (11) and the pole structure (31), said method comprising the steps of connecting the electric machine to the exhaust gas turbocharger via the clutch (5), and, at a rotational speed n_{ATL} of the exhaust gas turbocharger which is higher than a rated rotational speed n_{kontS} of the flywheel (10), inactivating the electric machine for driving the flywheel (10) but causing said electric machine (20) to absorb excess energy which is available from the exhaust gas turbocharger in a generator mode of operation of the electric machine (20), and feeding said energy, into a motor vehicle onboard power system, while driving the flywheel by the exhaust gas turbocharger, and, at a rotational speed n_{ATL} of the exhaust gas turbocharger which is lower than the rated rotational speed n_{kontS}, using the electric machine (20) to drive the flywheel (10) when a rotational speed n_{S} of the flywheel (10) drops below the rated rotational speed n_{kontS}.

14. The method as claimed in claim 13, wherein at rotational speeds n_{ATL} of the exhaust gas turbocharger which correspond at least approximately to the rated rotational speed n_{kontS}, the flywheel (10) is accelerated by the exhaust gas turbocharger (1) with the clutch (5) closed.

15. The method as claimed in claim 13, wherein at rotational speeds n_{ATL} of the exhaust gas turbocharger which are lower than the rotational speed ns of the flywheel (10) the exhaust gas turbocharger (1) is driven by the flywheel (10) for the acceleration of the turbocharger.
